(19) United States
(12) Patent Application Publication
(10) Pub. No.: US 2025/0092947 A1
(43) Pub. Date: Mar. 20, 2025

(54) SHIFTER ASSEMBLY FOR ELECTRIC VEHICLE

(71) Applicant: Ford Global Technologies, LLC, Dearborn, MI (US)

(72) Inventors: Jacob Michael Haspiel, Ann Arbor, MI (US); Martin Delonis, Northville, MI (US); Michael Lozano, Detroit, MI (US)

(73) Assignee: Ford Global Technologies, LLC, Dearborn, MI (US)

(21) Appl. No.: 18/468,236

(22) Filed: Sep. 15, 2023

(51) Int. Cl. F16H 59/10; G05G 5/02; G05G 5/03; G05G 5/28

(52) U.S. Cl. CPC F16H 59/105; G05G 5/02; G05G 5/03; G05G 5/28; G05G 2505/00

(57) ABSTRACT

A shifter assembly for an electric vehicle includes a base, a shifter handle, and a plurality of actuators. The base defines an opening. The shifter handle extends through the opening of the base and is pivotably coupled to the base. Each actuator of the plurality of actuators are pivotably coupled to the base at a first end and pivotably coupled to the shifter handle at a second end that is opposite the first end. The plurality of actuators are configured to permit movement of the shifter handle relative to the base in a predetermined virtual pathway and inhibit movement of the shifter handle relative to the base outside the predetermined virtual path.

### FIELD

The present disclosure relates to a shifter assembly for an electric vehicle.

### BACKGROUND

The statements in this section merely provide background information related to the present disclosure and may not constitute prior art.

Electric vehicles differ from conventional motor vehicles because they are driven by one or more rechargeable battery packs having lithium-ion batteries, for example, or any other suitable electrical power storage units. As electric vehicles increase in power, operators may desire alternative modes and capabilities of engagement with the electric vehicle. For example, electric vehicles lack operator to vehicle physical feedback that is advantageous in conventional motor vehicles. Integration of alternative modes and capabilities of engagement with electric vehicles can be challenging.

The teachings of the present disclosure address these and other issues with alternative modes and capabilities of electric vehicles.

### SUMMARY

This section provides a general summary of the disclosure and is not a comprehensive disclosure of its full scope or all of its features.

In one form, the present disclosure provides a shifter assembly for an electric vehicle. The shifter assembly includes a base, a shifter handle, and a plurality of actuators. The base defines an opening extending therethrough. The shifter handle extends through the opening of the base and is pivotably coupled to the base. Each actuator of the plurality of actuators is pivotably coupled to the base at a first end of that actuator and pivotably coupled to the shifter handle at a second end of that actuator that is opposite the first end. The plurality of actuators are configured to permit movement of the shifter handle relative to the base in a predetermined virtual path and inhibit movement of the shifter handle relative to the base outside the predetermined virtual path.

In variations of the shifter assembly of the above paragraph, which can be implemented individually or in any combination: the base includes an upper plate defining the opening and a plurality of rigid supports, each rigid support extending downward from a peripheral portion of the upper plate, the first end of each actuator of the plurality of actuators pivotably coupled to a respective rigid support of the plurality of rigid supports; a vertical drive post secured to the upper plate of the base and a motor operatively connected to the vertical drive post and configured to move the base in a vertical direction between a deployed position and a retracted position; a lower plate configured to be secured to a structure of the electric vehicle, the lower plate defining an aperture, the vertical drive post is received in the aperture; a first vertical drive post secured to the base; a first motor operatively connected to the first vertical drive post and configured to move the base in a vertical direction between a deployed position and a retracted position; a second vertical drive post secured to the base; a second motor operatively connected to the second vertical drive post and configured to move the base in the vertical direction between the deployed position and the retracted position; a lower plate configured to be secured to a structure of the electric vehicle and defining a drive post aperture and a plurality of guide post apertures; a plurality of vertical guide posts secured to the base, each vertical guide post of the plurality of vertical guide posts being received in a respective guide post aperture of the plurality of guide post apertures; a vertical drive post secured to the base and received in the drive post aperture; a motor operatively connected to the vertical drive post and configured to move the base and the shifter handle in a vertical direction between a deployed position and a retracted position; a controller in communication with the plurality of actuators and configured to send instructions to the plurality of actuators, the instructions corresponding to the predetermined virtual path; a plurality of wires, each wire of the plurality of wires connected to the controller and a respective actuator of the plurality of actuators; the plurality of wires are ribbon wires; the plurality of actuators are electronic actuators; the plurality of actuators are linear actuators; the shifter handle includes a knob and a shaft, the shaft extending through the opening in the base; and a haptic motor is disposed within the knob.

In another form, the present disclosure provides a shifter assembly for an electric vehicle. The shifter assembly includes a base, a shifter handle, a plurality of actuators, a plurality of vertical drive posts, a plurality of vertical guide posts, and a plurality of motors. The base includes a plate and at least one rigid support extending downward from a peripheral portion of the plate. The plate defines an opening near a center portion thereof. The shifter handle extends through the opening of the plate and is pivotably coupled to the plate. Each actuator of the plurality of actuators is pivotably coupled to the at least one rigid support at a first end of that actuator and pivotably coupled to the shifter handle at a second end of that actuator that is opposite the first end. The plurality of actuators are configured to permit movement of the shifter handle relative to the base in a predetermined virtual path and inhibit movement of the shifter handle relative to the base outside the predetermined virtual path. The plurality of vertical drive posts are secured to the plate of the base. The plurality of vertical guide posts are secured to the plate of the base. Each motor is operatively connected to a respective vertical drive post of the plurality of vertical drive posts and configured to move the base in a vertical direction between a deployed position and a retracted position.

In variations of the shifter assembly of the above paragraph, which can be implemented individually or in any combination: the plurality of actuators are pivotably coupled to the shifter handle at a location that is below where the shifter handle is pivotably coupled to the base; a controller in communication with the plurality of actuators and configured to send instructions to the plurality of actuators, the instructions corresponding to the predetermined virtual path; a plurality of wires, each wire of the plurality of wires is connected to the controller and a respective actuator of the plurality of actuators; the plurality of wires are ribbon wires; the plurality of actuators are electronic actuators; the plurality of actuators are linear actuators; the shifter handle includes a knob and a shaft, the shaft extending through the opening in the plate; and a haptic motor is disposed within the knob.

In yet another form, the present disclosure provides a shifter assembly for an electric vehicle. The shifter assembly includes a base, a shifter handle, a plurality of electronic actuators, a plurality of vertical drive posts, a plurality of vertical guide posts, a plurality of motors, a lower plate, a controller, and ribbon wires. The base includes an upper plate and a plurality of rigid supports extending downward from a peripheral portion of the upper plate. The upper plate defines an opening near a center portion thereof. The shifter handle extends through the opening of the upper plate of the base and pivotably coupled to the upper plate of the base. Each electronic actuator of the plurality of electronic actuators being pivotably coupled to a respective rigid support of the plurality of rigid supports at a first end of that electronic actuator and pivotably coupled to the shifter handle at a second end of that electronic actuator that is opposite the first end. The plurality of electronic actuators are configured to permit movement of the shifter handle relative to the base in a predetermined virtual path and inhibit movement of the shifter handle relative to the base outside the predetermined virtual path. The plurality of vertical drive posts are secured to the upper plate of the base. The plurality of vertical guide posts are secured to the upper plate of the base. Each motor is operatively connected to a respective vertical drive post of the plurality of vertical drive posts and configured to move the base in a vertical direction between a deployed position and a retracted position. The lower plate is configured to be secured to a support structure of the electric vehicle and defines a plurality of drive post apertures and a plurality of guide post apertures. Each vertical drive post of the plurality of vertical drive posts is received in a respective drive post aperture of the drive post apertures. Each vertical guide post of the plurality of vertical guide posts is received in a respective guide post aperture of the plurality of guide post apertures. The controller is in communication with the plurality of electronic actuators and configured to send instructions to the plurality of electronic actuators. The instructions corresponding to the predetermined virtual path. Each ribbon wire of the plurality of ribbon wires is connected to the controller and a respective electronic actuator of the plurality of electronic actuators. Each rigid support of the plurality of rigid supports engages the lower plate when the base is in the retracted position and is spaced apart from the lower plate when the base is in the deployed position.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a battery pack and motors according to the principles of the present disclosure;

FIG. 2 is a side view of the vehicle of FIG. 1 including a shifter assembly according to the principles of the present disclosure;

FIG. 3 is a top perspective view of the shifter assembly of FIG. 2 with a base of the shifter assembly in an extended position and a shifter handle of the shifter assembly in an extended state;

FIG. 4 is a bottom perspective view of the shifter assembly of FIG. 2 with the base of the shifter assembly in the extended position and the shifter handle of the shifter assembly in the extended state;

FIG. 5 is a top perspective view of the shifter assembly of FIG. 2 with the base of the shifter assembly in a retracted position and the shifter handle of the shifter assembly in the retracted state;

FIG. 6 is a bottom perspective view of the shifter assembly of FIG. 2 with the base of the shifter assembly in the retracted position and the shifter handle of the shifter assembly in the retracted state;

FIG. 7 is a bottom perspective view of the shifter assembly of FIG. 2 with the base of the shifter assembly in the extended position and the shifter handle of the shifter assembly in the extended state, and with the shifter handle pivoted relative to the base;

FIGS. 8A and 8B are example virtual pathways based on selected vehicle modes of the shifter assembly of FIG. 2 according to the principles of the present disclosure; and

FIG. 9 is a block diagram showing components of the shifter assembly of FIG. 2.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

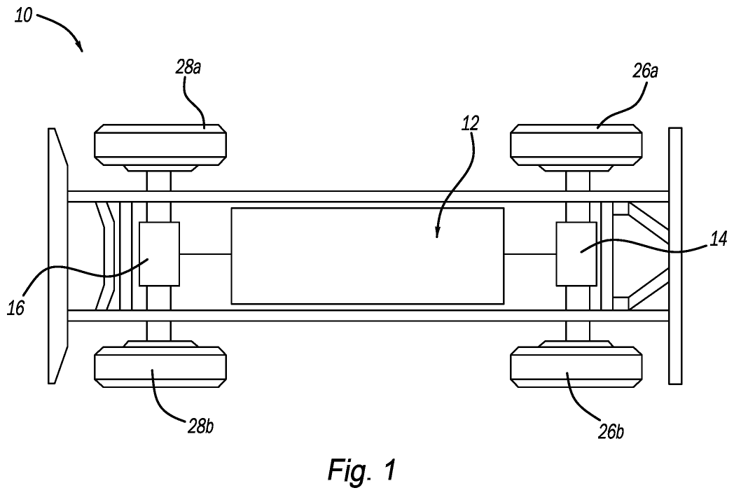

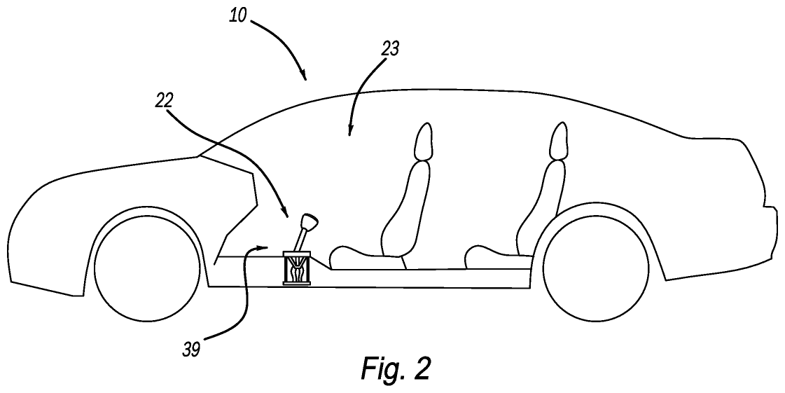

With reference to FIGS. 1 and 2, a vehicle 10 such as an electric vehicle is provided. In the example provided, the electric vehicle is a battery electric vehicle (BEV). In other examples, the electric vehicle may be a hybrid electric vehicle (HEV), a plug-in electric vehicle (PHEV), or a fuel cell vehicle, among others. The vehicle 10 includes a battery pack or battery structure 12 (FIG. 1), a first or rear motor 14 (FIG. 1) such as an electric motor, a second or front motor 16 (FIG. 1) such as an electric motor, and a shifter assembly 22 (FIG. 2). The battery pack 12 may be rechargeable and may include lithium-ion batteries or any other suitable electrical power storage units. The battery pack 12 may be disposed at various locations of the vehicle 10 and may be mounted to a vehicle frame. In this way, the battery pack 12 is supported by the vehicle frame and is remote from a passenger cabin (not shown) and cargo compartments (not shown) of the vehicle 10, therefore, not occupying space that would otherwise be available for passengers or cargo. The battery pack 12 powers the rear motor 14 to drive a set of rear wheels 26a, 26b via a rear axle. Similarly, the battery pack 12 powers the front motor 16 to selectively drive a set of front wheels 28a, 28b via a front axle. In other forms, not specifically shown, the vehicle 10 may only include the front motor 16 or the rear motor 14.

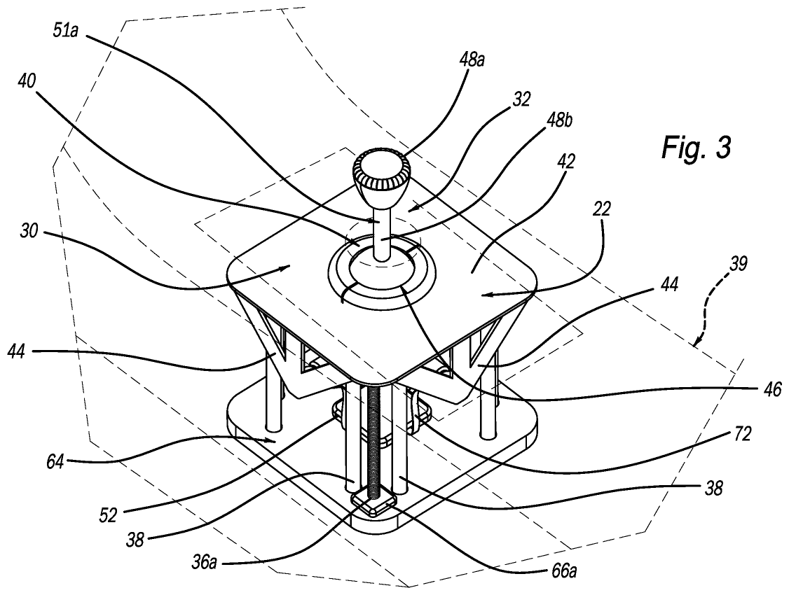

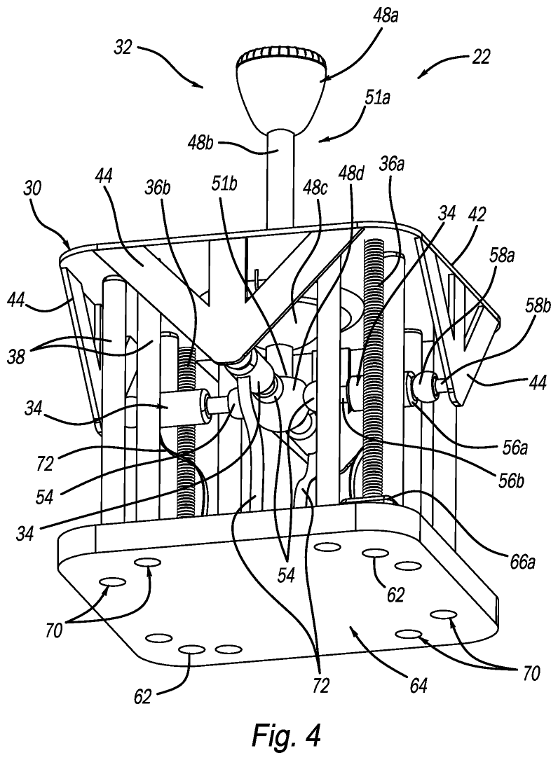

With reference to FIG. 2, the shifter assembly 22 is disposed at a center console 39 located in a front row 23 of the vehicle 10. The shifter assembly 22 may be mounted to a stationary structure of the vehicle 10 such as a vehicle floor, for example. With reference to FIGS. 3 and 4, the shifter assembly 22 includes a base 30, a shifter handle 32, a plurality of actuators 34 (FIG. 4), one or more vertical drive posts 36a, 36b, and one or more vertical guide posts 38. One or more components or parts of the shifter assembly 22 may be located within a transmission tunnel of the vehicle 10 such that the components are hidden from view and inaccessible by occupants located in an occupant cabin of the vehicle 10. For example, the shifter handle 32 is the only part of the shifter assembly 22 accessible by an occupant in the occupant cabin and the base 30, the plurality of actuators 34, the vertical drive posts 36a, 36b and the vertical guide posts 38 may be hidden and inaccessible by an occupant in the occupant cabin.

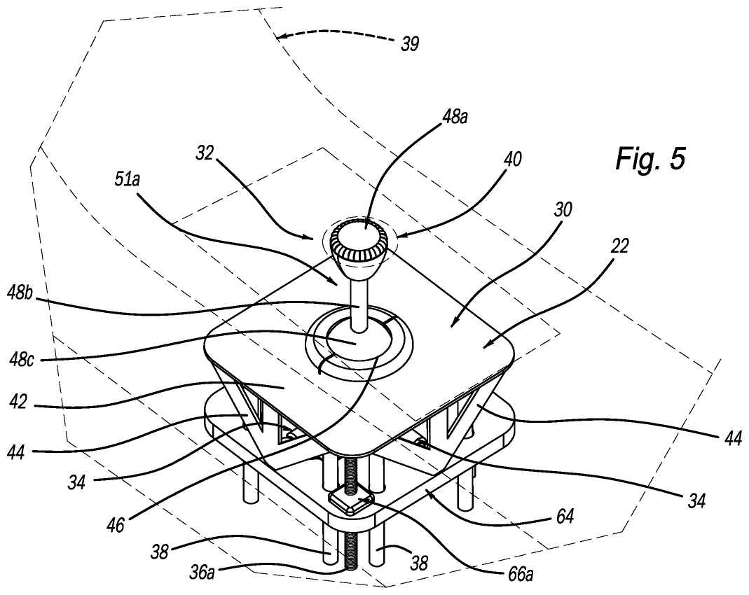

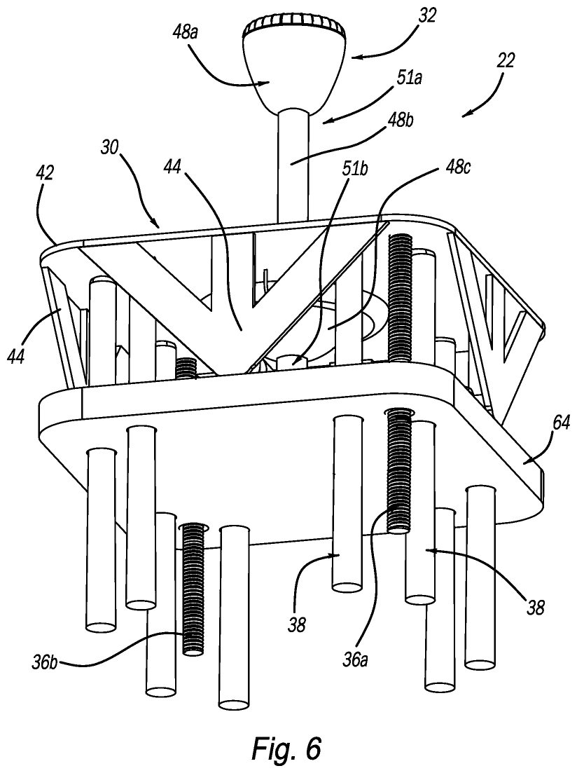

With additional reference to FIGS. 5 and 6, the base 30 is moveable vertically between a retracted position in which the shifter handle 32 is located at least partially within an opening 40 (FIG. 5) of the center console 39, and an extended position (FIGS. 3 and 4) in which the shifter handle 32 extends through the opening 40 (FIG. 3) of the center console 39. It should be understood that the shifter handle 32 is accessible by an occupant within the occupant cabin when the base 30 is in the retracted position and the extended position. The base 30 includes a plate 42 and a plurality of supports 44. In the example illustrated, the plate 42 includes an opening 46 (FIG. 5) extending therethrough. The opening 46 extends through the plate 42 near or at a center portion of the plate 42. The opening 46 is vertically aligned with the opening 40 of the center console 39 and is configured to receive the shifter handle 32. In the example illustrated, the plate 42 has a square shape when viewed from the top. In some forms, the plate 42 may have a rectangular shape, a circular shape, or any other suitable shape.

In the example illustrated, each support 44 has a triangular shape when viewed from a corresponding side of the shifter assembly 22. The supports 44 are positioned around a periphery of the plate 42 and extend downward from the periphery of the plate 42. In some forms, the supports 44 may have a semi-circular shape, a rectangular shape, or any other suitable shape. The supports 44 are rigid so as to not be able to bend or be forced out of shape when a force is applied by the operation of the actuators 34 and the shifter handle 32 via the actuators 34. In some forms, one support (not shown) may extend downward from and around the periphery of the plate 42 instead of a plurality of rigid supports 44 extending downward from and disposed around the periphery of the plate 42.

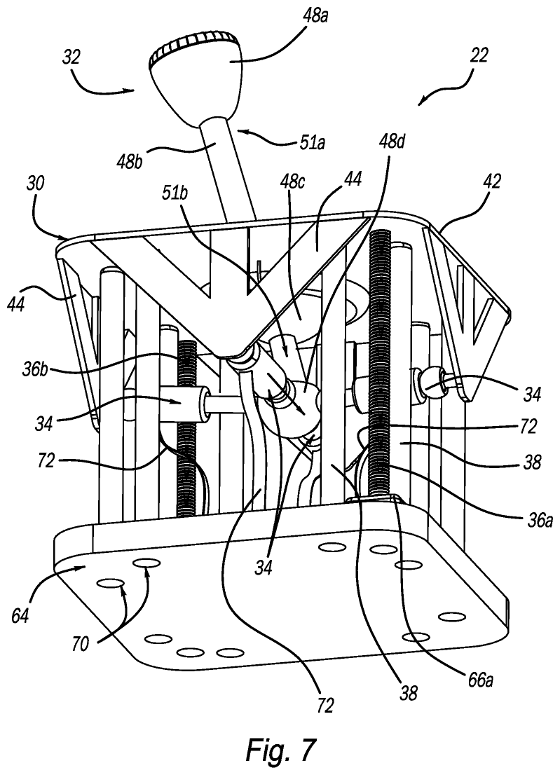

The shifter handle 32 extends through the opening 46 of the plate 42 and is coupled to the plate 42. In this way, the shifter handle 32 moves with the base 30 as the base 30 moves vertically between the retracted position and the extended position. That is, when the base 30 is in the retracted position, the shifter handle 32 is in the retracted state (FIGS. 5 and 6), and when the base 30 is in the extended position, the shifter handle 32 is in the extended state (FIGS. 3 and 4). With reference to FIG. 7, the shifter handle 32 is pivotably coupled to the plate 42 such that the shifter handle 32 may move relative to the base 30 in a predetermined virtual pathway, which is described in more detail below. The shifter handle 32 includes a knob 48a, a shaft 48b, base pivot portion 48c, and an actuator pivot portion 48d.

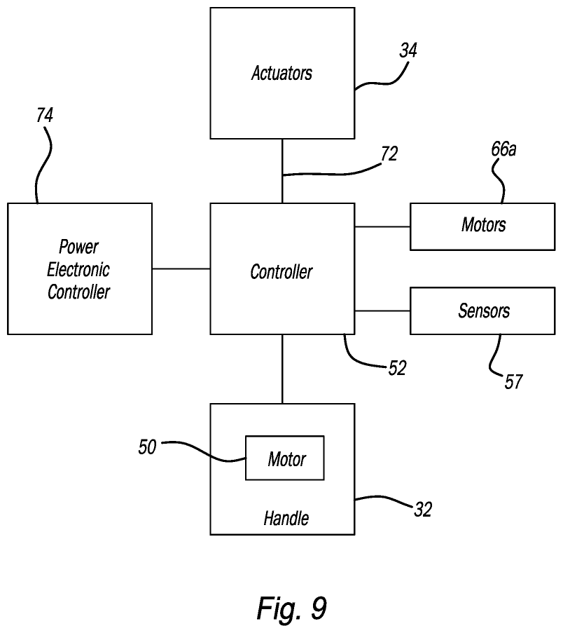

The knob 48a is disposed at an upper end 51a of the shaft 48b and is configured to be graspable by a driver of the vehicle 10. In some forms, a motor 50 (FIG. 9) is disposed within the knob 48a of the handle 32 and is configured to provide tactical feedback to the knob 48a by using vibrations, thereby providing an enhanced user experience to the driver based on an operating mode of the vehicle 10. In one form, the motor 50 is a haptic motor, for example. In some forms, the knob 48a includes an electronic display device (not shown). A controller 52 (FIG. 9) may be configured to instruct the electronic display device to display a visual indicator that corresponds to the selected operating mode. One example of such a shifter handle including a knob having an electronic display device is disclosed in the U.S. Patent Application titled “SYSTEM AND METHOD FOR OPERATING AN ELECTRIC VEHICLE,” which is filed concurrently with this application and is commonly owned with the present application and the contents of which are incorporated herein by reference in its entirety.

With continued reference to FIGS. 5 and 6, the base pivot portion 48c is located within the opening 46 of the plate 42 and is disposed along the shaft 48b at a location between the knob 48a and the actuator pivot portion 48d. The base pivot portion 48c is also pivotably coupled to the plate 42 such that the shifter handle 32 may move in a predetermined virtual pathway relative to the plate 42. In the example illustrated, the base pivot portion 48c has a spherical shape so as to form a ball joint mechanism with the plate 42. The actuator pivot portion 48d is disposed at a lower end 51b (FIGS. 4 and 7) of the shaft 48b and is configured to be pivotably coupled to the plurality of actuators 34. In the example illustrated, the actuator pivot portion 48d has a semi-spherical shape. In some forms, the actuator pivot portion 48d may have a spherical shape, for example, or any other suitable shape that permits a pivoting connection to the actuators 34. With reference to FIG. 4, a plurality of sockets 54 are disposed around the actuator pivot portion 48d and are configured to receive respective actuators 34 of the plurality of actuators 34.

The plurality of actuators 34 are pivotably coupled to the supports 44 of the base 30 at a first end and pivotably coupled to the actuator pivot portion 48d of the shifter handle 32 at a second end that is opposite the first end. The plurality of actuators 34 are configured to permit movement of the shifter handle 32 relative to the base 30 in a predetermined virtual pathway. In the example illustrated, the actuators 34 are electronic, linear actuators. In the example illustrated, when the shaft 48b is in a vertical position as shown in FIGS. 3-6, two of the actuators 34 are positioned substantially parallel to each other and substantially perpendicular to two other actuators 34 of the plurality of actuators 34, though other configurations can be used. Each actuator 34 of the plurality of actuators 34 are also positioned between the shifter handle 32 and a respective support 44 of the base 30. It should be understood that the actuators 34 may be positioned in various directions between the support 44 and the shifter handle 32.

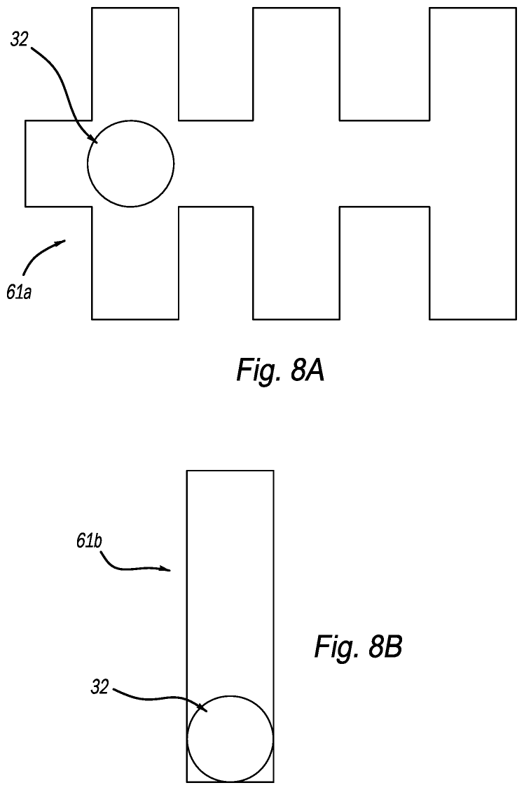

With continued reference to FIG. 4, each actuator 34 includes, inter alia, an outer housing 56a and an inner sleeve or rod 56b that is slidably engaged with the outer housing 56a. The controller 52 may be programmed to control the actuators 34 such that the rod 56b of each actuator 34 is permitted to travel a predetermined distance relative to the outer housing 56a in response to a vehicle mode selected, thereby allowing the shifter handle 32 to be moved in a predetermined virtual pathway. For example, if the vehicle mode selected corresponds to a 6-speed transmission mode, then each rod 56b of the actuators 34 is permitted to travel a predetermined distance relative to the outer housing 56a (i.e., the rod 56b is permitted to go in and out of the outer housing 56a a predetermined distance) depending on a position of the shifter handle 32 to permit the shifter handle 32 to be moved from that position along the virtual pathway 61a shown in FIG. 8A, while inhibiting the shifter handle 32 from moving outside the virtual pathway 61a. The position of the shifter handle 32 can be determined in any suitable manner. In one form, the position of the shifter handle 32 along the virtual pathway 61a may be determined by one or more sensors 57 (FIG. 9) that is in communication with the controller 52. In another form, the position of the shifter handle 32 can be determined based on the relative positions of the actuators 34. In another example, if the vehicle mode selected corresponds to an over boost mode or a sequential shifting mode, then each rod 56b of the actuators 34 is permitted to travel a predetermined distance relative to the outer housing 56a to permit the shifter handle 32 to be moved in the virtual pathway 61b shown in FIG. 8B, while inhibiting the shifter handle 32 from moving outside the virtual pathway 61b. The actuators 34 are programmed to provide for a plurality of vehicle modes being selected. Examples of such vehicle modes are disclosed in the U.S. Patent Application titled “SYSTEM AND METHOD FOR OPERATING AN ELECTRIC VEHICLE,” which is filed concurrently with this application and is commonly owned with the present application and the contents of which are incorporated herein by reference in its entirety.

In the example illustrated, the outer housing 56a has a cylindrical shape and is pivotably coupled to a respective support 44. Stated differently, an end of the outer housing 56a includes a socket 58a that is secured to a protrusion 58b extending from the respective support 44. In this way, the socket 58a and the protrusion 58b form a ball joint mechanism. The respective support 44 is rigid such that it is not forced out of shape or bent as the rod 56b slides in and out of the outer housing 56a. Although the present disclosure discloses the socket 58a as part of the outer housing 56a and the protrusion 58b as part of the support 44, it should be understood that the socket 58a may be part of the support 44 and the protrusion 58b may be part of the outer housing 56a without departing from the scope of the present disclosure. In the example illustrated, the rod 56b is pivotably coupled to a respective socket 54 of the shifter handle 32. Stated differently, an end of the rod 56b is coupled to the respective socket 54 of the shifter handle 32. In this way, the respective socket 54 and the end of the rod 56b form a ball joint mechanism. The end of the rod 56b may have a spherical shape, for example. Although the present disclosure discloses the socket 54 as part of the shifter handle 32, it should be understood that the socket 54 may be part of the rod 56b without departing from the scope of the present disclosure.

The vertical drive posts 36a, 36b are located at and secured to an underside of the plate 42 of the base 30. In the example illustrated, the vertical drive post 36a is secured to one corner of the plate 42 and the vertical drive post 36b is secured to another corner of the plate 42 that is diagonal to the vertical drive post 36a. In some forms, the vertical drive posts 36a, 36b may be located at other positions of the plate 42 such as near a center portion of the plate 42 or at a location between corners of the plate 42. Each vertical drive post 36a, 36b is threaded along a length thereof and is received in a respective drive post aperture 62 of a plate 64 spaced apart from plate 42 (i.e., the plate 64 is located below the plate 42 of the base 30). It should be understood that although the shifter assembly 22 of the present disclosure includes two vertical drive posts 36a, 36b, the shifter assembly 22 of the present disclosure may include one vertical drive post or more than two vertical drive posts without departing from the scope of the present disclosure.

Motors 66a (only one shown in the figures) are associated with the plate 64 (e.g., disposed on a top surface of the plate 64) and are operatively coupled to respective vertical drive posts 36a, 36b. In the example illustrated, the motor 66a is operatively coupled to the vertical drive post 36a and another motor (not shown) is operatively coupled to the vertical drive post 36b. Each motor 66a is configured to rotate a gear assembly (not shown), which, in turn, drives the vertical drive post 36a, 36b. In this way, the base 30 moves in a vertical direction between the extended position and the retracted position. When the base 30 is in the retracted position, the supports 44 may engage the plate 64 to inhibit further downward movement of the base 30. When the base 30 is in the extended position, the supports 44 are spaced apart from the plate 64. When the shifter handle 32 is in the retracted state, the knob 48a is located within the opening 40 of the center console 39 (FIG. 5). When the shifter handle 32 is in the extended state, the shaft 48b of the shifter handle 32 extends partially through the opening 40 of the center console 39 so that the knob 48a is located above the opening 40 of the center console 39 (FIG. 3). In some forms, each motor 66a may be covered by a cover (not shown). In an alternative form (not shown) a single motor 66a may be configured to drive more than one or all of the drive posts 36a, 36b, such as being coupled to each drive post 36a, 36b via gears, a pulley mechanism, or a chain and sprocket mechanism for example.

The guide posts 38 are located at and secured to the underside of the plate 42 of the base 30. In the example illustrated, two guide posts 38 are secured at a respective corner of the plate 42. In some forms, the guide posts 38 may be located at other positions of the plate 42 such as near a center portion of the plate 42 or at a location between corners of the plate 42. The two guide posts 38 located at a respective corner of the plate 42 where one vertical drive post 36a, 36b is located is positioned on opposing sides of the vertical drive post 36a, 36b (i.e., the vertical drive post 36a, 36b is located between the two guide posts 38). The guide posts 38 assist in stabilizing the base 30 as the base 30 moves between the retracted position and the extended position. In the example illustrated, each guide post 38 is unthreaded and configured to be received in a respective guide post aperture 70 of the plate 64. It should be understood that although the shifter assembly 22 of the present disclosure includes eight guide posts 38, the shifter assembly 22 of the present disclosure may include one guide post or any number of guide posts without departing from the scope of the present disclosure.

With reference to FIGS. 3 and 9 the controller 52 is in communication with the plurality of actuators 34 and the motors 66a, and may operate the actuators 34 and the motors 66a. That is, the controller 52 may provide power and/or send instructions (i.e., data) to each actuator 34 including power or instructions corresponding to the predetermined distance that the rod 56b is permitted to travel relative to the outer housing 56a in response to a vehicle mode selected and the position of the shifter handle 32, thereby allowing the shifter handle 32 to be moved in a predetermined virtual pathway and inhibiting the shifter handle 32 from moving outside the predetermined virtual pathway. The controller 52 may be in wired or wireless communication with the actuators 34, and if included, the sensors 57. In the example illustrated, a plurality of wires 72 are connected to the controller 52 and the actuators 34, thereby permitting the controller 52 to power and/or send instructions to the actuators 34. In the example illustrated, the wires 72 are ribbon wires, which provides flexibility as the base 30 moves between the retracted position and the extended position. It should be understood that the wires 72 may be any suitable wire that may power and/or provide instructions to the actuators 34 such as a cylindrical extrusion wire, for example.

In the example illustrated, the controller 52 is located on the upper side of the plate 64. In some forms, the controller 52 may be located on another part of the shifter assembly 22 (e.g., the base 30) or may be located remote from the shifter assembly 22 such as near or at a location housing a power electronic controller 74 (FIG. 9) of the vehicle 10. The power electronic controller 74 manages the flow of electrical energy delivered by the battery pack 12, controlling the speed of the motors 14, 16 and the torque each motor 14, 16 produces. The controller 52 may be in communication with the power electronic controller 74 and may send a signal to the power electronic controller 74 to control and/or adjust the speed of the motors 14, 16 and the torque each motor 14, 16 produces based on a position of the shifter handle 32 in the predetermined virtual pathway. An example of the controller 52 sending signals to the power electronic controller 74 to control and/or adjust the speed of the motors 14, 16 and the torque each motor 14, 16 produces based on a position of the shifter handle 32 in the predetermined virtual pathway is disclosed in U.S. Patent Application titled “SYSTEM AND METHOD FOR OPERATING AN ELECTRIC VEHICLE,” which is filed concurrently with this application and is commonly owned with the present application and the contents of which are incorporated herein by reference in its entirety.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A shifter assembly for an electric vehicle, the shifter assembly comprising:
a base defining an opening extending therethrough;
a shifter handle extending through the opening of the base and pivotably coupled to the base; and
a plurality of electronic actuators, each electronic actuator of the plurality of electronic actuators being pivotably coupled to the base at a first end of that electronic actuator and pivotably coupled to the shifter handle at a second end of that electronic actuator that is opposite the first end, wherein the plurality of electronic actuators are configured to permit movement of the shifter handle relative to the base in a predetermined virtual path and inhibit movement of the shifter handle relative to the base outside the predetermined virtual path.

2. The shifter assembly of claim 1, wherein the base includes:
an upper plate defining the opening; and
a plurality of rigid supports, each rigid support extending downward from a peripheral portion of the upper plate, the first end of each electronic actuator of the plurality of electronic actuators pivotably coupled to a respective rigid support of the plurality of rigid supports.

3. The shifter assembly of claim 2, further comprising:
a vertical drive post secured to the upper plate of the base; and
a motor operatively connected to the vertical drive post and configured to move the base in a vertical direction between a deployed position and a retracted position.

4. The shifter assembly of claim 3, further comprising a lower plate configured to be secured to a structure of the electric vehicle, the lower plate defining an aperture, wherein the vertical drive post is received in the aperture.

5. The shifter assembly of claim 1, further comprising:
a first vertical drive post secured to the base;
a first motor operatively connected to the first vertical drive post and configured to move the base in a vertical direction between a deployed position and a retracted position;
a second vertical drive post secured to the base; and
a second motor operatively connected to the second vertical drive post and configured to move the base in the vertical direction between the deployed position and the retracted position.

6. The shifter assembly of claim 1, further comprising a lower plate configured to be secured to a structure of the electric vehicle and defining a drive post aperture and a plurality of guide post apertures.

7. The shifter assembly of claim 6, further comprising:
a plurality of vertical guide posts secured to the base, each vertical guide post of the plurality of vertical guide posts being received in a respective guide post aperture of the plurality of guide post apertures;
a vertical drive post secured to the base and received in the drive post aperture; and
a motor operatively connected to the vertical drive post and configured to move the base and the shifter handle in a vertical direction between a deployed position and a retracted position.

8. The shifter assembly of claim 1, further comprising:
a controller in communication with the plurality of electronic actuators and configured to send instructions to the plurality of electronic actuators, the instructions corresponding to the predetermined virtual path; and
a plurality of wires, each wire of the plurality of wires connected to the controller and a respective electronic actuator of the plurality of electronic actuators.

9. The shifter assembly of claim 8, wherein the plurality of wires are ribbon wires.

10. (canceled)

11. The shifter assembly of claim 1, wherein the plurality of electronic actuators are linear actuators.

12. The shifter assembly of claim 1, wherein:
the shifter handle includes a knob and a shaft, the shaft extending through the opening in the base; and
a haptic motor is disposed within the knob.

13. A shifter assembly for an electric vehicle, the shifter assembly comprising:
a base including a plate and at least one rigid support extending downward from a peripheral portion of the plate, the plate defining an opening near a center portion thereof;
a shifter handle extending through the opening of the plate and pivotably coupled to the plate;
a plurality of actuators, each actuator including a housing and a sleeve slidably engaged with the housing, one of the housing and the sleeve of each actuator of the plurality of actuators being pivotably coupled to the at least one rigid support at a first end of that actuator and the other of the housing and the sleeve of each actuator of the plurality of actuators being pivotably coupled to the shifter handle at a second end of that actuator that is opposite the first end, wherein the plurality of actuators are configured to permit movement of the shifter handle relative to the base in a predetermined virtual path and inhibit movement of the shifter handle relative to the base outside the predetermined virtual path.

14. The shifter assembly of claim 13, wherein the plurality of actuators are pivotably coupled to the shifter handle at a location that is below where the shifter handle is pivotably coupled to the base.

15. The shifter assembly of claim 13, further comprising:
a controller in communication with the plurality of actuators and configured to send instructions to the plurality of actuators, the instructions corresponding to the predetermined virtual path; and
a plurality of wires, each wire of the plurality of wires is connected to the controller and a respective actuator of the plurality of actuators.

16. The shifter assembly of claim 15, wherein the plurality of wires are ribbon wires.

17. The shifter assembly of claim 13, wherein the plurality of actuators are electronic actuators.

18. The shifter assembly of claim 13, wherein the plurality of actuators are linear actuators.

19. The shifter assembly of claim 13, wherein:
the shifter handle includes a knob and a shaft, the shaft extending through the opening in the plate; and
a haptic motor is disposed within the knob.

20. A shifter assembly for an electric vehicle, the shifter assembly comprising:
a base including an upper plate and a plurality of rigid supports extending downward from a peripheral portion of the upper plate, the upper plate defining an opening near a center portion thereof;
a shifter handle extending through the opening of the upper plate of the base and pivotably coupled to the upper plate of the base;
a plurality of actuators, each actuator of the plurality of actuators being pivotably coupled to a respective rigid support of the plurality of rigid supports at a first end of that actuator and pivotably coupled to the shifter handle at a second end of that actuator that is opposite the first end, wherein the plurality of actuators are configured to permit movement of the shifter handle relative to the base in a predetermined virtual path and inhibit movement of the shifter handle relative to the base outside the predetermined virtual path;
a plurality of vertical drive posts secured to the upper plate of the base;
a plurality of vertical guide posts secured to the upper plate of the base;
a plurality of motors, each motor operatively connected to a respective vertical drive post of the plurality of vertical drive posts and configured to move the base in a vertical direction between a deployed position and a retracted position;
a lower plate configured to be secured to a support structure of the electric vehicle and defining a plurality of drive post apertures and a plurality of guide post apertures, wherein each vertical drive post of the plurality of vertical drive posts is received in a respective drive post aperture of the plurality of drive post apertures, wherein each vertical guide post of the plurality of vertical guide posts is received in a respective guide post aperture of the plurality of guide post apertures;
a controller in communication with the plurality of actuators and configured to send instructions to the plurality of actuators, the instructions corresponding to the predetermined virtual path; and
a plurality of ribbon wires, each ribbon wire of the plurality of ribbon wires connected to the controller and a respective actuator of the plurality of actuators,
wherein each rigid support of the plurality of rigid supports engages the lower plate when the base is in the retracted position and is spaced apart from the lower plate when the base is in the deployed position.

21. The shifter assembly of claim 20, wherein the plurality of actuators are electronic actuators.
